(19) United States
(12) Patent Application Publication
(10) Pub. No.: US 2024/0295343 A1
(43) Pub. Date: Sep. 5, 2024

(54) SAFETY DEVICE FOR ELECTRICAL APPLIANCES

(71) Applicant: STIEBEL ELTRON GMBH & CO. KG, Holzminden (DE)

(72) Inventors: Christian ARNEMANN, Hoexter (DE); Michael GROBE, Hoexter (DE)

(73) Assignee: STIEBEL ELTRON GMBH & CO. KG, Holzminden (DE)

(21) Appl. No.: 17/921,877

(22) PCT Filed: Apr. 27, 2021
(86) PCT No.: PCT/EP2021/060924

§ 371 Date: Feb. 28, 2024

(30) Foreign Application Priority Data
Apr. 28, 2020 (DE) 10 2020 111 516.4

(51) Int. Cl. F24H 9/20; H01H 1/20

(52) U.S. Cl. CPC F24H 9/2014; H01H 1/20

(57) ABSTRACT

The invention relates to a safety device (1) for the emergency deactivation of an electrical water heater or a heat pump, wherein the safety device (1) comprises at least one contact pair (70, 80, 90) having at least one first contact assembly (71, 81, 91) and at least one second contact assembly (72, 82, 92), which are designed to direct the current to supply the water heater or the heat pump in a contacted state, and to interrupt the current supply to the water heater or the heat pump in an open state, as well as comprising a retaining device (94) for retaining the second contact assembly (72, 82, 92) on a tension rod (40), wherein the tension rod (40) is designed to release the retaining device (94) and the second contact assembly (72, 82, 92) from the first contact assembly (71, 81, 91) in order to interrupt a current supply to the water heater or the heat pump. The safety device (1) also comprises a housing (10) having a cover (20) and a base element (30), wherein the base element (30) has guide elements (34) and positioning elements (32) for the cover (20), which cooperate with corresponding counter guide elements (22) and counter positioning elements (20d) of the cover (20).

The invention relates to a safety device for emergency deactivation of an electric water heater or a heat pump.

Safety devices for emergency deactivation of electric water heaters, such as electric instantaneous water heaters, are known from the prior art. Such safety devices establish a conductive connection between a contact arranged on a printed circuit board and a counter contact and disconnect this connection in an emergency.

DE 10 2017 000 438 A1 shows an embodiment of a known safety device 100 having a circuit board 110 and a contact carrier 120 soldered thereon and having a contact 122 arranged thereon in the form of a contact rivet. A carrier element 130 which accommodates the counter contact 132 is movable relative to the contact 122 in a spring-mounted manner in order to establish a conductive connection between the contact and the counter contact or to separate them. The carrier element 130 with the counter contact 132 is accommodated in a housing. In contrast, the contact carrier 120 with the contact rivet 122 arranged thereon is soldered to the circuit board 110 and contacts the counter contact 132 through an opening in the bottom of the housing. This known design of a safety device requires a great deal of assembly work when arranging the individual elements within the housing. In addition, the contact carriers must be placed very precisely on the circuit board in order to ensure exact contacting of the contacts projecting into the housing and the counter contacts located therein.

It is therefore the object of the present invention to provide an improved safety device for emergency deactivation of an electric water heater or a heat pump.

This object is achieved by a safety device for emergency deactivation of an electric water heater or a heat pump, which comprises at least one contact pair with at least one first contact assembly and at least one second contact assembly, which are adapted to conduct the current to supply the water heater or the heat pump in a contacted state and to interrupt the power supply to the water heater or the heat pump in an open state, and a retaining device for retaining the second contact assembly on a tension rod, wherein the tension rod is adapted to release the retaining device and the second contact assembly from the first contact assembly to interrupt a power supply to the water heater or the heat pump. The safety device further comprises a housing having a cover and a base element, wherein the base element has guide elements and positioning elements which cooperate with counter guide elements and counter positioning elements of the cover corresponding thereto.

This specific design of the housing enables easy assembly of the safety device, in which all components of the safety device are first arranged in the cover and then secured therein by the base element. The guide and positioning elements as well as the counter guide elements and counter positioning elements corresponding thereto ensure correct alignment between the base element and the cover.

In a further design of the safety device according to the invention, it can be provided that the cover has guide pins as counter guide elements. These guide pins, in addition to ensuring precise positioning of the base element relative to the cover, can also serve to accommodate and guide further elements of the safety device, for example to accommodate springs and/or a carrier element for the counter contacts, which can be guided along the guide pins.

Besides the guide pins, and in addition thereto, further guide elements, such as projections or grooves, can of course be provided to ensure exact positioning between the cover and the base element.

In a further embodiment according to the invention, it can be provided that the base element has at least one wall element which, in the assembled state of the safety device, extends between two at least approximately parallel side walls of the cover.

Such a wall element ensures that the side walls of the cover are at a defined distance from one another. This is necessary to prevent jamming of the contact carrier moving in the cover between the side walls. By providing such a wall element, which increases the dimensional stability of the cover, additional stabilizing elements on the outside of the cover can be dispensed with, thus enabling a reduction in the size of the safety device.

In a further embodiment of the safety device according to the invention, the safety device comprises at least two contact pairs and the at least one wall element of the base element is positioned between the at least two contact pairs. In addition to increasing the stability of the cover, such a wall element can reliably prevent the occurrence of an arc between two adjacent contact pairs as well as a flashover.

Typically, electrical appliances with high power consumption, such as water heaters or heat pumps, are connected to a three-phase AC power supply. Therefore, the safety device according to the invention can have three contact pairs so that each of the three phases can be disconnected by the safety device in an emergency. In this case, the base element has two wall elements arranged such that one wall element is located between two adjacent contact pairs.

If the guide elements of the base element are integrated into the wall elements of the base element, this results in a simplified structure of the base element, which overall can result in a reduction in the size of the safety device.

If the safety device has a circuit board on which the at least one first contact assembly is arranged, it can also be provided that the guide pins of the cover engage in corresponding receptacles in the circuit board. This enables exact alignment of the housing on the circuit board, which ensures precise positioning of the first and second contact assemblies relative to one another.

In one design of the safety device according to the invention, the first contact assembly consists of a first and a second contact part, such as a contact rivet, and the second contact assembly is formed by a double-angled contact bridge. In this case, the two contact parts forming the first contact assembly can be two contact rivets arranged on the circuit board, which make contact with two points of the contact bridge. Alternatively, the contact bridge can also have special contact elements, such as contact rivets, at the points of contact with the contact rivets.

If the base element according to the invention has two wall elements aligned parallel to each other, it can further be provided that a rod-shaped stabilizing element is arranged between them. Such a stabilizing element ensures that the distance between the two wall elements of the base element is not changed, for example during assembly of the safety device, whereby guide elements likewise integrated in the wall elements retain their defined position.

In the safety device according to the invention, it can further be provided that the cover and the base element comprise pairs of cooperating latching elements. This allows the cover and the base element to be fixed together to secure the position of the components accommodated in the housing in order to subsequently attach the housing to a circuit board. This results in further simplification of the assembly of the safety device.

Further advantageous designs and embodiments are described below with reference to the accompanying figures.

In the figures:

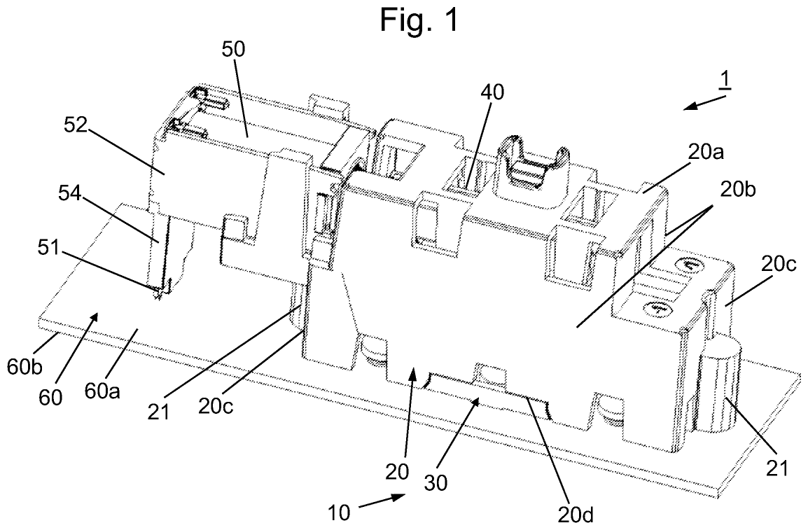

FIG. 1: shows a schematic illustration of a safety device according to an exemplary embodiment of the present invention;

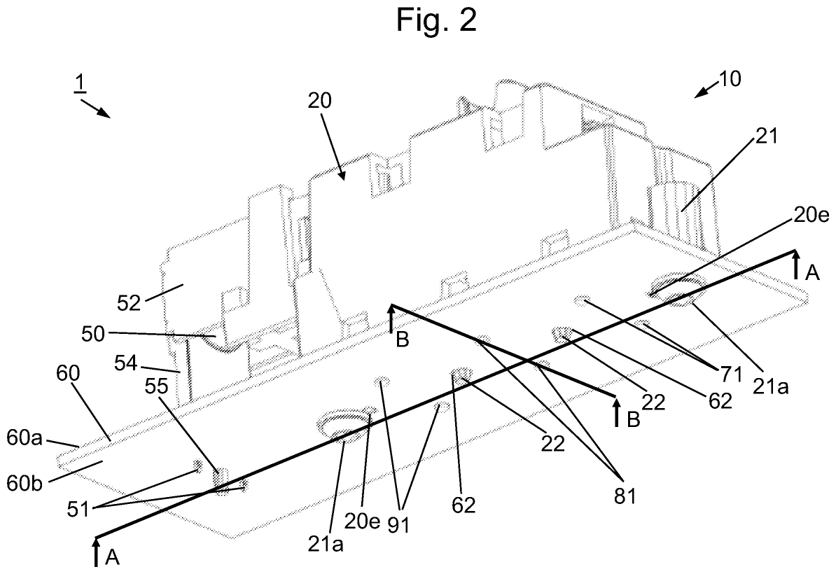

FIG. 2: shows a further schematic illustration of the safety device according to FIG. 1,

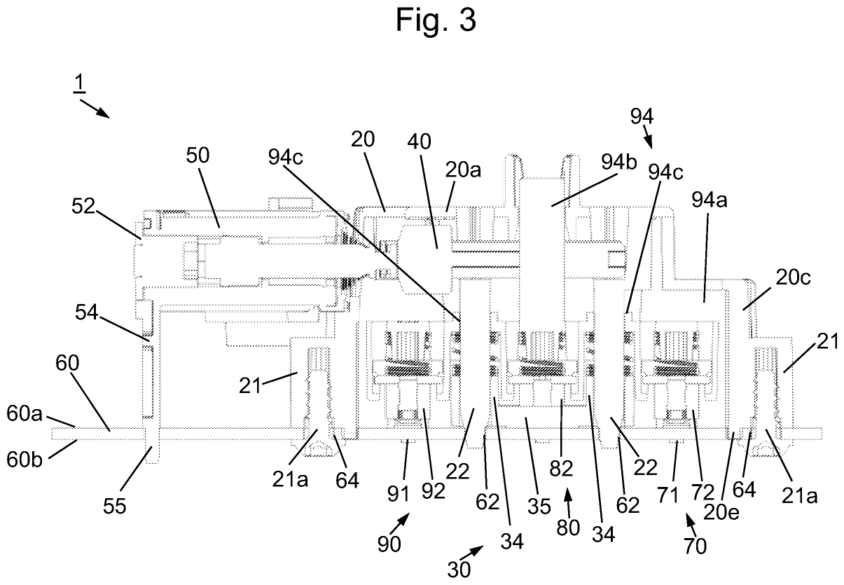

FIG. 3: shows a sectional view of the safety device according to FIGS. 1 and 2 along the section line A-A,

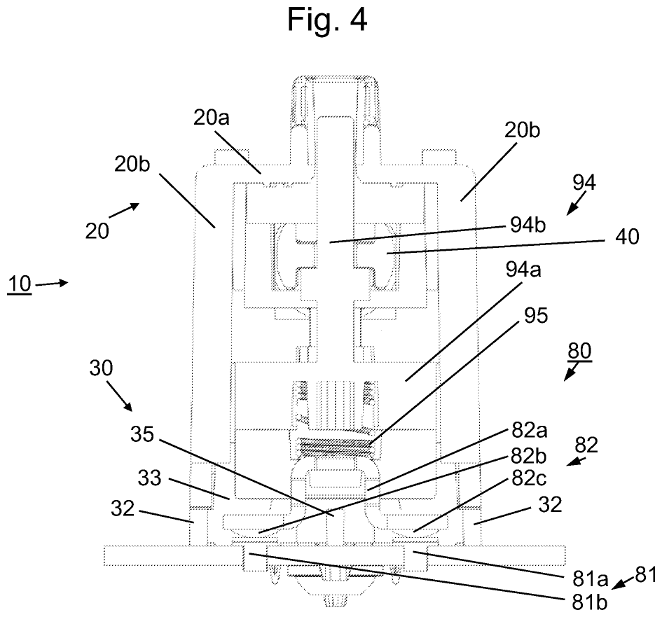

FIG. 4: shows a sectional view of the safety device according to FIGS. 1 and 2 along the section line B-B,

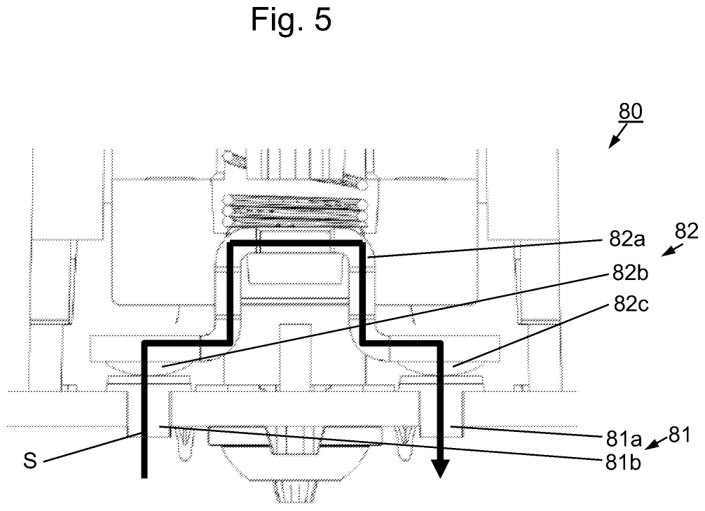

FIG. 5: shows a detail of the sectional view according to FIG. 4,

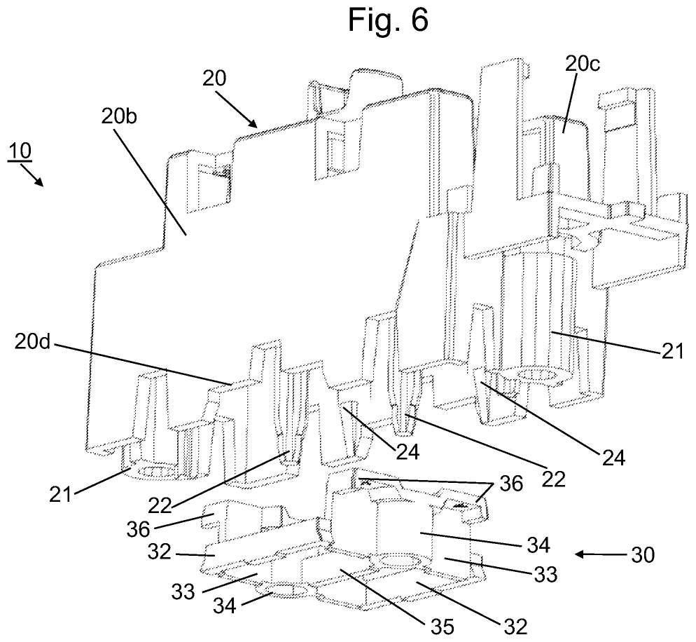

FIG. 6: shows a schematic illustration of the housing of the safety device according to FIGS. 1 and 2, and

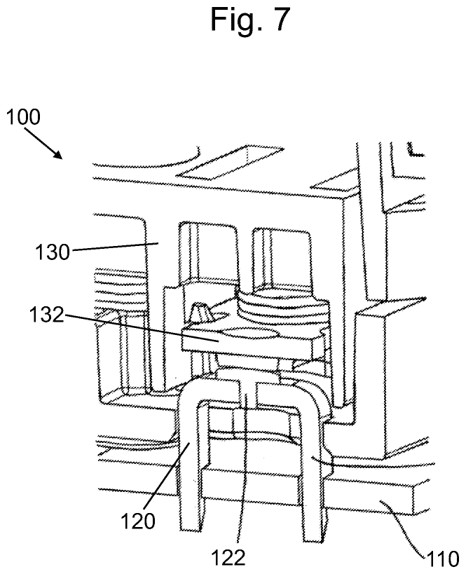

FIG. 7: shows a schematic illustration of a safety device according to the prior art.

FIG. 1 shows a schematic illustration of a safety device 1 according to an exemplary embodiment of the present invention. The safety device 1 comprises a housing 10 with a cover 20 and a base element 30 in which further components of the safety device 1, such as a tension rod 40, are accommodated, a coil 50 which actuates the tension rod 40, and a circuit board 60, on the upper side 60a of which the housing 10 with the other components of the safety device 1 is attached. The coil 50 is received in a coil carrier 52 which is arranged on the left side of the housing 20 in FIG. 1 and at a distance from the upper side 60a of the circuit board 60. The cover 20 of the housing 10 has an upper side 20a, two side faces 20b extending parallel to each other and two end faces 20c also extending parallel to each other. Furthermore, two screw tubes 21 are arranged on the end faces 20c of the cover 20, by means of which the cover 20 is fastened to the circuit board 60. For this purpose, two screws 21a are screwed from the lower side 60b of the circuit board 60 through corresponding holes in the circuit board 60 into the screw tubes 21 (compare FIG. 2).

The cover 20 has two guide pins 22 which extend from the inside of the upper side 20a in the direction of the circuit board 60 (compare FIGS. 3 and 5). The guide pins 22 project beyond the side faces 20b and engage in positioning aids in the form of two holes 62 in the circuit board 60.

Positioning pins 20e which further support a positionally accurate arrangement of the housing 10 on the circuit board 60 are arranged on the cover 20 on the side thereof facing the circuit board 60 in the region of the screw tubes 21. The positioning pins 20e do not protrude from the lower side 60b of the printed circuit board 60 but are preferably flush therewith. The positioning pins 20e arranged in the immediate vicinity of the screw tubes 21 also prevent the housing 10 from twisting or slipping on the circuit board 60, in particular when tightening the screws 21a (compare FIGS. 2 and 3).

The coil carrier 52 lies with its right-hand side in FIG. 1 in a corresponding receptacle of the cover 20. At its end facing away from the housing 10, the coil carrier 52 has a support element 54 which extends towards the circuit board 60 and supports the coil carrier 52 with the coil 50 on the circuit board 60. At the end of the support element 54 directed towards the circuit board 60, the support element is provided with a positioning element in the form of a pin 55 which extends through a corresponding hole in the circuit board 60 (compare FIGS. 2 and 3). As can further be seen in particular in FIGS. 1 and 2, the electrical connections 51 of the coil 50 are fed through the support element 54 to the lower side 60b of the circuit board 60.

The base element 30 consists substantially of two webs 32 arranged parallel to one another and two wall elements 33 connecting the ends of the webs 32 to one another so that the base element has an at least approximately rectangular shape (compare FIG. 5). Integrated into the wall elements 33 are guide elements 34 in the form of guide sleeves which extend perpendicular to the plane formed by the webs 32 and the wall elements 33. The distance between the guide sleeves 34 corresponds to the distance between the guide pins 22 of the cover 20 so that they extend through the guide sleeves 34 in the assembled state. Furthermore, a rod-shaped stabilizing element 35 extends between the guide sleeves 34 and parallel to the webs 32.

As can be seen in FIG. 1, the side faces 20b of the cover 20 have recesses 20d at their lower edges, the shape and size of which correspond to the shape and size of the webs 32 of the base element 30, so that the latter can positively engage with the webs 32 in the recesses 20d. In addition, the ends of the webs 32 as well as the ends of the recesses 20d are provided with slopes corresponding to each other to further facilitate insertion of the base element 30 into the cover 20.

Arranged at the upper edges of the wall elements 33 are projections 36. Together with the projections 24 provided on the inner sides of the side walls 20d of the cover 20, they form pairs of latching elements to secure the base element 30 in the cover 20 (compare FIG. 6).

The safety device 1 according to FIG. 1 has three contact pairs 70, 80, 90. Each of these three contact pairs 70, 80, 90 has a first contact assembly 71, 81, 91, each of which is formed by two contact rivets 71a, 71b, 81a, 81b, 91a, 91b which are arranged on the circuit board 60 and rest with their heads on the upper side 60a of the circuit board 60 and protrude with their shanks from the lower side 60b thereof (compare FIG. 2).

It should be noted that in another embodiment of the safety device 1, more or fewer contact pairs 70, 80, 90 can also be provided, wherein the cover 20 and base element 30 are then adapted accordingly.

In addition, it is also possible to equip the safety device 1 without middle contact pairs, without having to adapt the components. In this connection it is important that the switch is loaded symmetrically in terms of force, thus, for example, three contact pairs or two contact pairs are possible as equipment, in which case they must then be located on the outside.

Furthermore, the contact pairs 70, 80, 90 comprise a second contact assembly 72, 82, 92, which is formed in each case by a double-wound contact bridge 72a, 82a, 92a so that each of these contact bridges 72a, 82a, 92a has two contact points for contacting the contact rivets 71a, 71b, 81a, 81b, 91a, 91b. In FIG. 4, the contact pair 80 can be seen. As can also be seen there, the second contact assembly 82, in addition to the contact bridge 82a, can also have additional contact elements in the form of contact rivets 82b, 82c. Of course, in this case, the second contact assemblies 72, 92 also comprise corresponding pairs of contact rivets 72b, 72c, 92b, 92c, in addition to the contact bridges 72a, 92a.

The second contact assemblies 72, 82, 92 are resiliently held in a contact holder 94 by means of a spring 95. The contact holder 94 has a substantially cuboid base body 94a and an actuating pin 94b extending vertically upwards therefrom. In the assembled state of the safety device 1, the actuating pin 94b extends through the tension rod 40 and further through an opening in the upper side 20a of the cover 20 (compare FIG. 3). Furthermore, the base body 94a of the contact holder 94 has two vertical through openings 94c, which are aligned with the guide pins 22 of the cover 20 and along which the contact holder 94 is movable for establishing and disconnecting the connection between the first contact assembly 71, 81, 91 and the second contact assembly 72, 82, 92.

To assemble the safety device 1, the tension rod 40 is first inserted into the cover 20. Then, the contact holder 94 with the counter contacts 72, 82, 92 resiliently held therein is placed in the cover 20 in such a manner that the actuating pin 94a extends through the tension rod 40 and the opening in the cover 20. In doing so, the contact holder 94 is guided along the guide pins 22 which extend through the through openings 94c of the contact holder 94. Two springs 95 can then be placed onto the guide pins 22 and finally the base element 30 can be slid onto the guide pins 22 to interlock with the projections 24. The assembly thus created can then be placed on the upper side 60a of the circuit board 60 with the first contact assembly 71, 81, 91 already attached thereto and fastened to the circuit board 60 by means of the screws 21a. In doing so, the guide pins 22, which project beyond the lower side of the housing 20 and which engage in the openings 62 of the circuit board 60, ensure correct alignment of the second contact assemblies 72, 82, 92 with respect to the first contact assemblies 71, 81, 91 located on the circuit board 60.

In the contacted state, the contact holder 94 with the second contact assemblies 72, 82, 92 is pressed downwards in the housing 10 against the force of the springs 95 placed on the guide pin 22 to such an extent that a conductive contact is established between the first contact assemblies 71, 81, 91 and the second contact assemblies 72, 82, 92. The tension rod 40 is interlocked with the actuating pin 94b such that it secures the contact holder 94 in this position. In an emergency, the tension rod 40 is actuated by the coil 50, thereby releasing the interlock between the tension rod 40 and the actuation pin 94, and the contact holder 94 is moved along the guide pins 22 away from the first contact assemblies 71, 81, 91 by spring force.

FIG. 5 shows an enlarged detail of the cross-sectional view according to FIG. 4, with the contact pair 80. As can be seen in FIG. 5, the contact rivets 82b, 82c of the second contact assembly 82 rest against the contact rivets 81a, 81b of the first contact assembly 81 in the contacted state. The arrow S shown in FIG. 5 represents the current flow through the contact pair 80. As can be seen there, the current flows first through the contact rivet 81a of the first contact assembly 81, the contact rivet 82b of the second contact assembly 82 and further via the contact bridge 82a, the contact rivet 82c to the contact rivet 81b of the first contact assembly 81.

If the circuit is interrupted by lifting the contact holder 94, with the second contact assembly 82 lifting off the first contact assembly 81, both the second contact assembly 82 and the contact rivet 81b of the first contact assembly 81 are in a de-energized state.

To ensure the function of the safety device 1, it is imperative that the contact holder 94 can be moved unhindered in the housing 10. In this regard, the wall elements 33 of the base element 30 ensure that the distance between the side walls 20b of the cover 20 is maintained, and in particular does not decrease, thereby preventing the contact holder 94 from rubbing against or jamming in the cover 20.

Furthermore, the above-described design of the base element 30 makes it possible to make the cover 20, and thus the entire safety device, leaner since additional stabilizing elements for the cover 20 can be dispensed with.

Furthermore, as described above, the housing 10 of the safety device 1 according to the invention facilitates the assembly of the safety device 1, in particular by providing the guide pins 22 with the contact holder 94 guided thereon as well as the base element 30, which secures the contact holder 94 in the cover 20 of the housing 10 and enables a final precisely fitting assembly on the circuit board 60.

1. A safety device (1) for emergency deactivation of an electric water heater or a heat pump, the safety device (1) comprising:
at least one contact pair (70, 80, 90) having at least one first contact assembly (71, 81, 91) and at least one second contact assembly (72, 82, 92), which are adapted to conduct the current to supply the water heater or the heat pump in a contacted state, and to interrupt the power supply to the water heater or the heat pump in an open state,
a retaining device (94) for retaining the second contact assembly (72, 82, 92) on a tension rod (40) ,
wherein the tension rod (40) is adapted to release the retaining device (94) and the second contact assembly (72, 82, 92) from the first contact assembly (71, 81, 91) in order to interrupt a power supply to the water heater or the heat pump,
characterized in that the safety device (1) further comprises a housing (10) having a cover (20) and a base element (30), wherein the base element (30) has guide elements (34) and positioning elements (32) for the cover (20) which cooperate with counter guide elements (22) and counter positioning elements (20d) of the cover (20) corresponding thereto.

2. The safety device according to claim 1,
characterized in that the cover (20) has guide pins (22) as counter guide elements.

3. The safety device according to claim 1 or 2,
characterized in that the base element (30) has at least one wall element (33) which, in the assembled state of the safety device (1), extends between two at least approximately parallel side walls (20b) of the cover.

4. The safety device according to claim 3,
characterized in that the safety device (1) has at least two contact pairs (70, 80, 90) and in that the at least one wall element (33) of the base element (30) is positioned between the at least two contact pairs (70, 80, 90).

5. The safety device according to claim 3 or 4,
characterized in that the guide elements (34) of the base element (30) are integrated in the wall elements ((33) of the base element (30).

6. The safety device according to claim 2, having a circuit board (60) on which the at least one contact assembly (71, 81, 91) is arranged,
characterized in that the guide pins (22) of the cover (20) engage in receptacles (62) in the circuit board (60) corresponding thereto.

7. The safety device according to claim 1,
characterized in that the first contact assembly (71, 81, 91) consists of a first and a second contact rivet (71a, 71b; 81a, 81b; 91a, 91b), and the second contact assembly (72, 82, 92) is formed by a double-angled contact bridge (72a, 82a, 92a).

8. The safety device according to claim 7,
characterized in that the base element (30) has two wall elements (33) aligned parallel to each other, between which a rod-shaped stabilizing element (35) is arranged.

9. The safety device according to any one of the preceding claims, characterized in that the cover (20) and the base element (30) have pairs of cooperating latching elements (24, 36).
